(19) United States
(12) Patent Application Publication
(10) Pub. No.: US 2003/0024307 A1
(43) Pub. Date: Feb. 6, 2003

(54) Muscle testing device

(76) Inventor: Willis Guild Boyden, Pompano Beach, FL (US)

Correspondence Address: WILLIS GUILD BOYDEN, 4684 NE 8th AV, POMPANO BEACH, FL, 33064, US

(21) Appl. No.: 09/910,611

(22) Filed: Jul. 23, 2001

(51) Int. Cl. G01L 3/24

(52) U.S. Cl. 73/379.01

(57) ABSTRACT

The muscle testing device, allows a person to determine, without assistance, the openness of their autonomic nervous system through determining the strength of a muscle, usually the arm muscle. The force of the muscle is applied against a gradually increasing known force, through the use of a solenoid. When the forces are equal a contact opens alerting a microprocessor to indicate this force on a display, through the use of a look-up table within the computer.

### BACKGROUND OF THE INVENTION

At present, muscle testing, to determine if a person's autonomic system is open (eating grass) or closed (ready to flee) requires the presence of two people; the subject holds one arm straight out and rigid. If the other person is easily able to force the arm down, the subject is closed; if not, the subject is open, allowing further testing; for instance, determining the presence in the subjects body of certain pathogens.

A disadvantage to this method is that it requires two persons; the method also is quite qualitative. The present invention requires only one person, and gives a quantitative result.

The USPTO data file reveals several patents dealing with muscle testing and kinesiology. For instance in U.S. Pat. No. 6,155,993 Scott teaches a method for measuring strength in limb movements. Wise in U.S. Pat. No. 5,855,539 describes a device where the foot is used to measure the strength in an outstretched arm, and Crandall in U.S. Pat. No. 4,922,925 measures hand joint strength by the use of a computer.

Other patents such as U.S. Pat. Nos. 6,149,550, 5,662,591, 5,090,421, 5,054,774, 4,824,103, 4,819,485, 4,732,038, 4,592,371, and 4,337,780 measure strengths of various muscle.

None of these patents are similar to the standard test of the ability of the outstretched arm, to withstand an increasing force against it.

The present invention duplicates this standard test by applying an increasing force against the outstretched arm, and quantitatively determining the exact force when the arm gives way.

### DESCRIPTION OF THE DRAWINGS

FIG. 1 is a pictorial drawing of the invention.

FIG. 2 is a cross-sectional drawing of the mechanical parts of the invention.

FIG. 3 is a symbolic representation of the electric circuit.

List of Elements in the Drawings

| | |
|---|---|
| 1. | enclosure |
| 2. | plastic ring |
| 3. | display |
| 4. | tension switch |
| 5. | on/off switch |
| 6. | clamp A |
| 7. | clamp B |
| 8. | enclosure base |
| 9. | table |
| 10. | ring clamp |
| 11. | plug |
| 12. | transformer |
| 13. | solenoid |
| 14. | solenoid support |
| 15. | arm support |
| 16. | arm |
| 17. | clamp support |
| 18. | solenoid element |
| 19. | contact |
| 20. | contact connector |
| 21. | insulator |
| 22. | contact wire |
| 23. | solenoid wire |
| 24. | solenoid wire return |
| 25. | printed circuit board |
| 26. | microprocessor |
| 27. | oscillator capacitor A |
| 28. | oscillator capacitor B |
| 29. | crystal |
| 30. | oscillator resistor |
| 31. | latch |
| 32. | display |
| 33. | voltage regulator |
| 34. | interrupt transistor |
| 35. | interrupt bias resistor |
| 36. | interrupt control resistor |
| 37. | interrupt pulldown resistor |
| 38. | negative capacitor A |
| 39. | negative diode A |
| 40. | bridge rectifier A |
| 41. | bridge rectifier B |
| 42. | bridge rectifier C |
| 43. | bridge rectifier D |
| 44. | negative diode B |
| 45. | negative capacitor B |
| 46. | positive capacitor |
| 47. | battery diode |
| 48. | battery |
| 49. | bias resistor A |
| 50. | bias resistor B |
| 57. | bias resistor C |
| 52. | bias resistor D |
| 53. | bias resistor E |
| 54. | bias resistor F |
| 55. | differential transistor A |
| 56. | differential resistor |
| 57. | current resistor |
| 58. | differential transistor B |
| 59. | compensation resistor |
| 60. | power transistor bias resistor |
| 61. | power transistor |

### DETAILED DESCRIPTION OF THE DRAWINGS

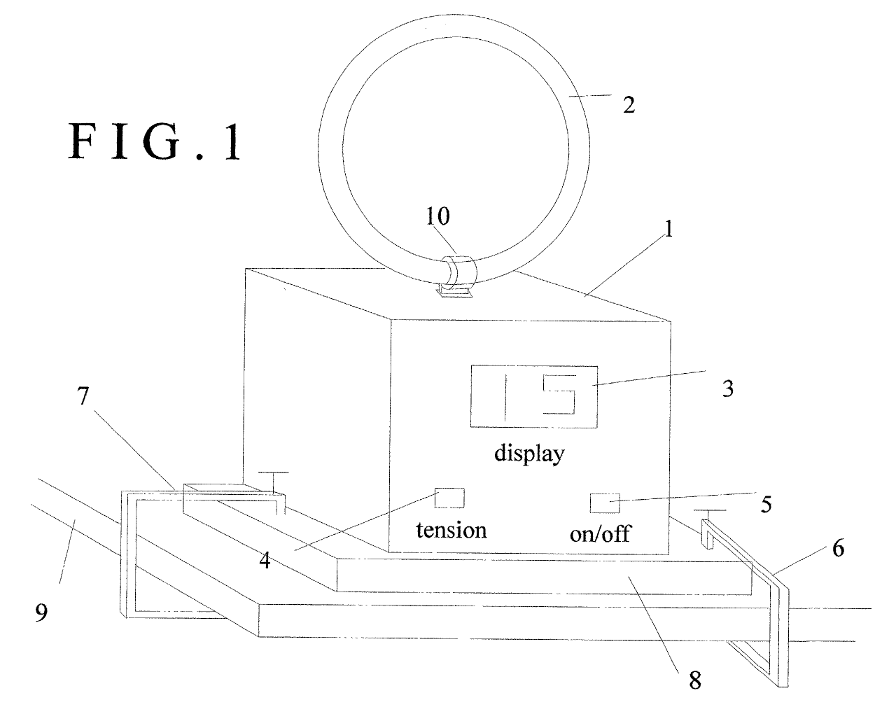

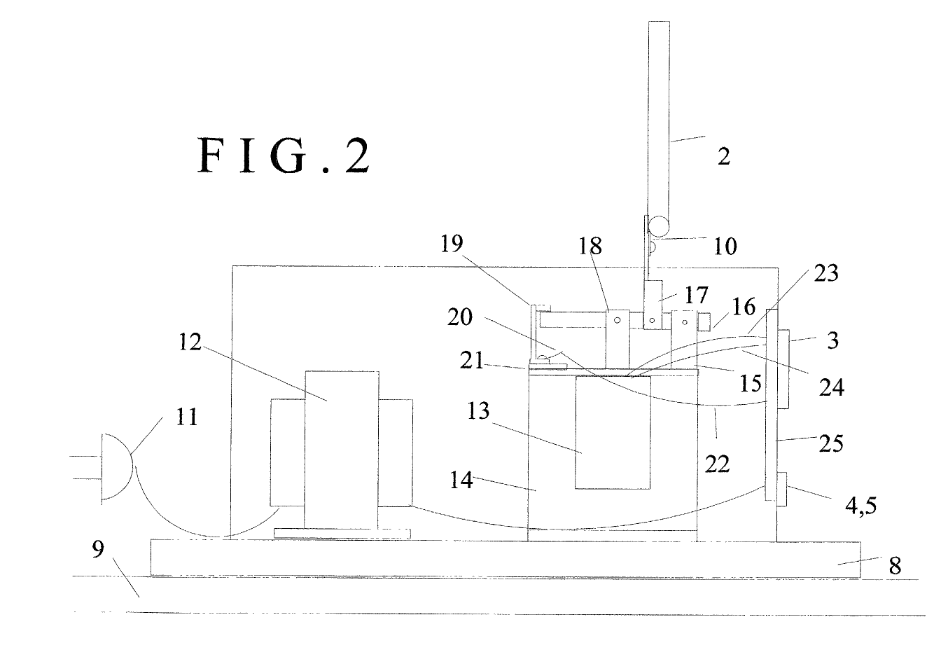

FIG. 1 is a physical embodiment of the Muscle Testing Device. The on/off switch, 5, turns the unit on. The tension switch, 4, is depressed when the subject is ready to perform a test; the tension is shown on the display, 3. The muscle testing device is held to the table by clamp A, 6, and clamp B, 7, through the enclosure support, 8. The plug, 11, is inserted in the AC receptacle. The subject places his hand in the plastic ring, 2, which exerts a vertical force to the internal mechanism through the ring clamp, 10. FIG. 2 shows the internal mechanism comprising transformer, 12, solenoid, 13, and solenoid support, 14. Vertical force is applied by the subject to plastic ring, 2, ring clamp, 10, and clamp support, 17, and the arm applies a vertical force against the solenoid element, 18, and contact, 19. The solenoid, 13, applies a gradually increasing downward counter force to the arm, 16, through the solenoid element, 18.

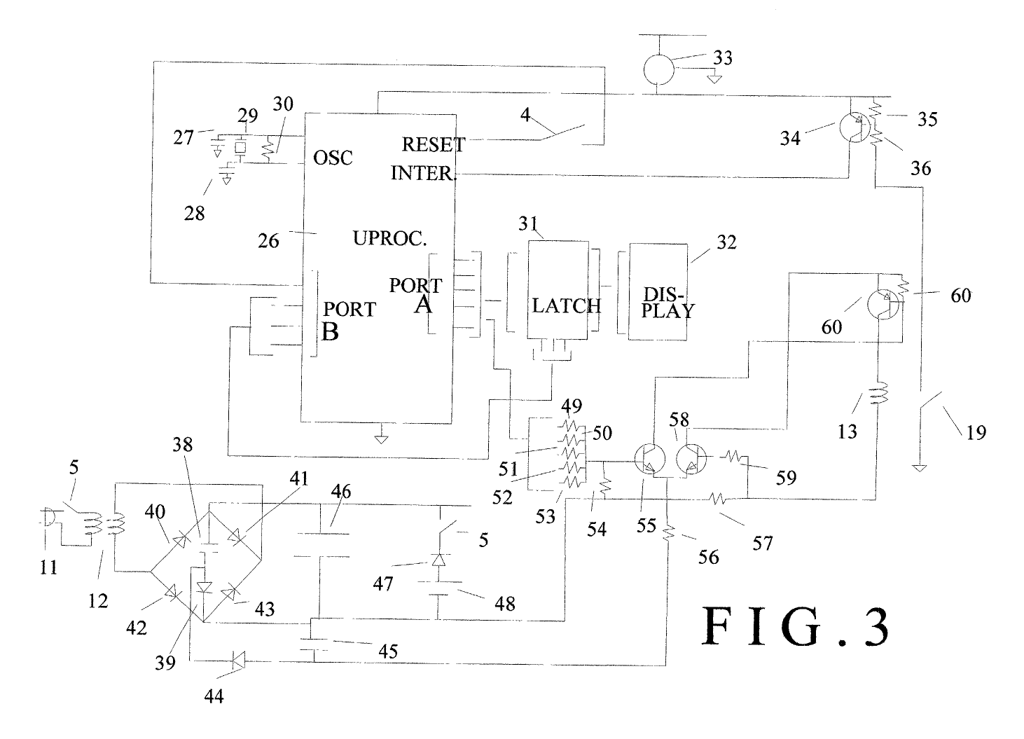

FIG. 3 is a symbolic representation of the electrical circuit. When the on/off switch, 5, is turned on, power is supplied to the unit through transformer, 12. Positive voltage is supplied by the bridge circuit comprising bridge rectifier A, 40, bridge rectifier B, 41, bridge rectifier C, 42, and bridge rectifier D, 43, and positive capacitor, 46. Negative voltage is supplied by negative capacitor A, 38, negative diode A, 39, negative diode B, 44, and negative capacitor B, 45. A lower voltage is supplied to the microprocessor, 26, latch, 31, and display, 32, by the voltage regulator, 33.

When the tension switch, 4, is depressed, action is initiated by the microprocessor, 26, by a routine which turns on port A and puts 0 through 4 in a binary sequence; this sequence is applied to bias resistor A, 49, bias resistor B, 50, bias resistor C, 51, bias resistor D, 52, and bias resistor E, 53, resulting in a gradually increasing step of voltage across bias resistor F, 54. This forces a similar voltage across the current resistor, 57, through the action of the current amplifier comprising differential transistor A, 55, differential transistor B, 58, differential resistor, 56, power transistor, 61, and power transistor bias resistor, 60. This results in a gradually increasing step of current through the solenoid, 13, exerting a similarly increasing downward force against the arm, 16.

When this downward force exceeds the upward force applied by the subject against the arm, 16, through the plastic ring, 2, the contact, 19, is opened, and the microprocessor conducts, an interrupt routine, as the interrupt transistor, 34, is turned off This interrupt routine causes the present condition of the port A outputs to be transferred, through a look-up table, to a tension. This tension is sent to post A, where it is latched, through the action of part B outputs 0 through 2, into the latch, 31, and sent on to the display, 32.

The microprocessor, 26, is driven by oscillator elements comprising oscillator capacitor A, 27, oscillator capacitor B, 28, crystal 29, and oscillator resistor, 30.

Operation of the Muscle Testing Device

To operate the muscle testing device, the subject places an outstretched hand in the plastic ring, palm-down, exerts an upward force on the ring, and depresses the tension switch; in several seconds the display will indicate, in pounds, this force. If this value is close to his maximum value, as determined by previous measurements, his autonomic system is open; if this value is considerably below his maximum value his system is closed, and in the fight-or-flight mode.

I claim:

1. A muscle testing device comprising:
means for applying a gradually increasing known force against an unknown steady force,
means for determining when said known force equals said unknown force,
means for displaying said known force.

2. A muscle testing device comprising:
a solenoid, wherein said solenoid is connected to a rigid structure,
an arm, wherein one side of said arm is allowed to pivot on a support connected to said rigid structure, the middle of said arm being connected to the element of said solenoid, the other end of said arm bearing on an electrical contact,
a ring, wherein said ring is connected, through an extension, to said arm.

3. A muscle testing device comprising:
a solenoid, wherein said solenoid is connected to a rigid structure,
an arm, wherein one side of said arm is allowed to pivot on a support connected to said rigid structure, the middle of said arm being connected to the element of said solenoid, the other end of said arm bearing on an electrical contact,
a ring, wherein said ring is connected, through an extension, to said arm,
means of delivering a known gradually increasing current to said solenoid,
means of determining when said electrical contact becomes open,
means of converting said known current to a force,
means of displaying said force.
wherein means of delivering a known gradually increasing current comprises a microprocessor, an output of said microprocessor feeds a resistor matrix that gradually increases the current of said solenoid by a current amplifier, wherein said microprocessor initiates this action through a routine that is started by the reset function in said microprocessor,
wherein means of determining when said electrical contact becomes open comprises said contact being connected to the interrupt of said microprocessor, and initiating a routine wherein said known current is converted, through a look-up table in said microprocessor, to a force,
wherein said means of displaying said force comprises a latch and display said latch being connected to said microprocessor, said display being connected to said latch.
